(19) United States
(12) Patent Application Publication
(10) Pub. No.: US 2018/0046163 A1
(43) Pub. Date: Feb. 15, 2018

(54) PROJECT PLANNING DEVICE AND METHOD FOR CONFIGURING AND/OR PARAMETERIZING AUTOMATION COMPONENTS OF AN AUTOMATION SYSTEM

(71) Applicant: Phoenix Contact GmbH & Co. KG, Blomberg (DE)

(72) Inventors: Benno HEINES, Detmold (DE); Philipp BRUNE, Leopoldshoehe (DE); Gerhard FREITAG, Detmold (DE)

(21) Appl. No.: 15/557,675

(22) PCT Filed: Mar. 11, 2016
(86) PCT No.: PCT/EP2016/055245

§ 371 Date: Sep. 12, 2017

(30) Foreign Application Priority Data
Mar. 13, 2015 (DE) 10 2015 103 727.0

(51) Int. Cl. G05B 19/042

(52) U.S. Cl. CPC G05B 19/0426; G05B 2219/25204; G05B 2219/23258

(57) ABSTRACT

The invention relates to a project planning device and a method for configuring and/or parameterizing automation components of an automation system. The project planning device of the invention has a user interface and a network interface via which it can be connected to a network of an actual automation system. The project planning device is operable to create a target configuration and/or a target parameterization for an automation system, and to analyze a connected actual automation system with respect to the actual configuration and/or actual parameterization thereof. According to the invention, the project planning device is configured for automatically detecting accesses to the target configuration and/or the target parameterization based on predefinable access types, and for automatically initiating and performing the analyzing in response to a detected access and/or in response to a signal which is a predefinable regularly recurring signal.

### CROSS-REFERENCE TO RELATED APPLICATIONS

This application claims the benefit under 35 U.S. C. § 371 of International Application No. PCT/EP2016/055245 filed on Mar. 11, 2016, which in turn claims the benefit of German application 102015 103 727.0 filed on Mar. 13, 2015, the entire content of each of which is hereby incorporated by reference in its entirety.

### FIELD

Embodiments of the invention relate to a project planning device and a method for configuring and/or parameterizing automation components of an automation system.

### BACKGROUND

Automation solutions in factory automation, process industry, and mechanical engineering are nowadays often implemented using industrial networks such as fieldbuses or Industrial Ethernet. Such networks allow for a selective combination and arrangement of a number of devices and controllers, hereinafter referred to as automation components, to form an automation system. In this case, the automation components are at the same time network components and must support the respective network protocol to be able to exchange data with one another over the network.

The selection, combination, and arrangement of the automation components to form an automation system is usually made using an engineering tool on a project planning device which has a user interface for this purpose. Here, a configuration and/or parameterization for the automation system and its components is created. The configuration and/or parameterization usually comprises specific properties and settings for both the employed industrial network and the employed automation components and may reach a high degree of complexity, in particular if a plurality of network protocols have to be complied with and/or if the network comprises a combination of fieldbuses such as INTERBUS and Industrial Ethernet such as PROFINET, for example. In addition, the degree of complexity also depends on the type and number of the automation components used.

Once the required automation components have been actually provided and connected to the network, the configuration and/or parameterization generated using the engineering tool can be uploaded from the engineering tool that is connected to the network onto the actual components. For this purpose, the configuration and/or parameterization data are first converted and/or compiled, by the engineering tool, into a format suitable for the automation components so that they can be interpreted, applied, and/or executed by the automation components after having been transferred.

Usually, an analysis of the automation system is performed in conjunction with the configuring and/or parameterizing and in particular prior to the transmission of the configuration and/or parameterization data, as to whether all required components have actually been provided and are available and whether they are actually suitable for the intended configuration and/or parameterization. The result of the analysis is displayed by the engineering tool. If the analysis revealed errors or problems, these must first be corrected before the configuration and/or parameterization data can be uploaded onto the automation components.

The conversion of the configuration and/or parameterization data, the analysis of the automation system, the transmission of the converted configuration and/or parameterization data to the automation components, and the application or execution of the data by the automation components are processes which a user usually has to start manually nowadays.

Since the created configuration and/or parameterization often exhibits a high degree of complexity, as already mentioned above, the conversion or compilation of the relevant configuration and/or parameterization data sometimes requires considerable computational performance and/or time. Thus, usually a not insignificant waiting time has to be expected from the start of the compilation to the uploading of the generated data onto the automation components. Therefore, a modification to the configuration and/or parameterization for an automation system as made using the engineering tool will only have a very late effect.

### SUMMARY

An object of embodiments of the present invention therefore is to accelerate at least one of the processes of the background art to make it more user-friendly for the user.

This object is achieved by a device or the project planning device with the features of independent claim 1 and by a method with the features of independent claim 11.

Advantageous embodiments of the project planning device according to the invention are specified in the dependent claims. The features and advantages stated there similarly also apply to the method embodiments of the invention.

Embodiments of the invention accordingly propose a device and in particular a project planning device for configuring and/or parameterizing automation components of an automation system. The device or project planning device has a user interface and a network interface and can be connected to a network of an actual automation system via the latter, and is operable to create a target configuration and/or a target parameterization for an automation system, and to analyze an actual automation system with respect to the actual configuration and/or actual parameterization thereof, when it is connected via the network interface. However, the project planning device is in particular operable firstly to automatically detect accesses to the target configuration and/or to the target parameterization based on predefinable access types, and secondly to automatically initiate and perform the analyzing in response to a detected access and/or in response to a signal which is a predefinable regularly recurring signal. Creating herein also refers to the modifying or editing of a target configuration. Types of accesses that are to be detected may be defined as user accesses as such, or user accesses to specific devices, parameters or properties, for example. By appropriately defining the relevant access types, accesses to the target configuration and/or target parameterization can be managed selectively. For example, certain accesses might have a direct effect, and other accesses might have no effect at all. Alternatively or additionally, an analysis may be initiated and performed in a predefined cycle, for example. Preferably, the analyzing also includes the evaluation of the determined information.

Furthermore, a method is proposed for configuring and/or parameterizing automation components of an automation system, which method is in particular intended for being performed using the project planning device and comprises the steps of:
connecting a network of an actual automation system;
creating a target configuration and/or a target parameterization for an automation system;
automatically detecting accesses to the target configuration and/or the target parameterization based on predefined access types;
automatically initiating and performing the analyzing of the connected actual automation system with respect to the actual configuration and/or actual parameterization thereof, in response to a detected access and/or in response to a signal which is a predefinable regularly recurring signal.

### BRIEF DESCRIPTION OF THE DRAWINGS

These and further features of the present invention will also be apparent from the exemplary embodiment which will be explained in more detail below with reference to the accompanying drawings. It goes without saying that the features can not only be used in the respective described combination but also in other combinations or alone, without thereby departing from the scope of the invention. In the drawings:

FIG. 1 schematically illustrates an automation system comprising a controller and two devices which are connected, via a network, to each other and to a project planning device according to embodiments of the invention;

FIG. 2 schematically illustrates a plurality of threads that are executed in parallel by the project planning device of embodiments of the invention.

### DETAILED DESCRIPTION

Embodiments of the present invention provide many advantages. For example, the actual state of the configuration and/or parameterization of the automation system connected to the project planning device is analyzed automatically without need for the user to instruct this himself. Current information on the actual configuration and/or actual parameterization, which are usually an important prerequisite for various further processes within the context of the configuration, are now always available in updated form. This is very convenient and time-saving for the user.

According to an advantageous embodiment of the invention, the project planning device is configured for automatically analyzing the actual configuration and/or actual parameterization in comparison to the created target configuration and/or target parameterization. Preferably, the project planning device is furthermore configured for automatically presenting the analysis result, in particular immediately after availability thereof. Thus, the user is notified about any problems at an early stage and essentially as early as possible, for example as to whether a device already provided in the target configuration is actually not yet provided in the actual configuration, and/or whether a specific parameter set in the target parameterization for a particular device would not be supported by the actual device. The user is now able to identify and resolve such problems already prior to the compiling of the configuration and/or parameterization data resulting from the target configuration and/or target parameterization.

In an advantageous further embodiment of the invention, the project planning device is configured for automatically segmenting the actual configuration and/or actual parameterization based on the at least one available analysis result, and for automatically analyzing individual segments of the actual configuration and/or actual parameterization. This leads to further time savings, since only the first analysis of the actual configuration and/or actual parameterization has to be a complete one, whereas the following analyzes only need to consider individual segments of the actual configuration and/or actual parameterization. This will be useful for analyzes, for example, that are performed in response to a regularly recurring signal, and in particular at least one different segment of the actual configuration and/or actual parameterization is analyzed at each repetition of the signal. The segmentation may be accomplished based on structural and/or semantic conditions, for example. However, an analysis of the entire actual configuration and/or actual parameterization can now also be done more quickly thanks to the segmentation, because a plurality of segments can be examined simultaneously in parallel analysis threads, for example.

In a preferred embodiment of the invention, the project planning device is configured for automatically segmenting the target configuration and/or target parameterization and for automatically associating the segments of the actual configuration and/or of the actual parameterization with the respectively corresponding segments of the target configuration and/or target parameterization. Furthermore in this case, the project planning device is preferably configured for automatically analyzing a segment of the actual configuration and/or of the actual parameterization in response to a detected access to a segment of the target configuration and/or target parameterization associated with this segment. This advantageously provides for a particularly selective and efficient automatic analysis of the actual configuration and/or actual parameterization.

In another, complementary or alternative further embodiment of the invention, the project planning device is configured for automatically converting configuration and/or parameterization data which are resulting from the target configuration and/or target parameterization into a format that can be interpreted by the automation components, in response to a detected access or in response to a signal which is a predefinable regularly recurring signal. The automatic converting of the data may be performed immediately after the automatic analysis, for example, provided that the latter has not identified any problems in the actual configuration and/or actual parameterization. Advantageously, the converted data will then be available in the interpretable format for being uploaded onto the automation components.

In a particularly preferred embodiment of the invention, the project planning device is configured for automatically converting configuration and/or parameterization data which are resulting from at least one segment of the target configuration and/or target parameterization into a format that can be interpreted by the automation components, in response to a detected access to this at least one segment of the target configuration and/or target parameterization or in response to a signal which is a predefinable regularly recurring signal. This may in particular mean that as soon as the user has made a modification in a segment of the target configuration and/or target parameterization, the automatic analysis and then the automatic conversion of the configuration and/or parameterization data are performed for this segment, and then the converted data will be available in the interpretable format for being uploaded onto the automation components.

In a further preferred embodiment of the invention, the project planning device may also be configured for automatically uploading the configuration and/or parameterization data converted into the interpretable format onto at least one automation component. Thus, a modification in the target configuration and/or the target parameterization substantially has a direct effect on the actual automation system, for example.

Furthermore, in a particularly preferred embodiment of the invention the project planning device is moreover configured to automatically initiate the application or execution of the configuration data and/or parameterization data uploaded onto the automation component. Such a project planning device offers the user a very close coupling between the target state and the actual state, which is approximately comparable with the actuation of a light switch and the expectation of the user to have a shortest possible waiting time until perceiving an effect of the action.

In a further embodiment of the invention, the functionality of the project planning device for configuring and/or parameterizing automation components of an automation system is preferably provided in the form of a software component of an engineering tool.

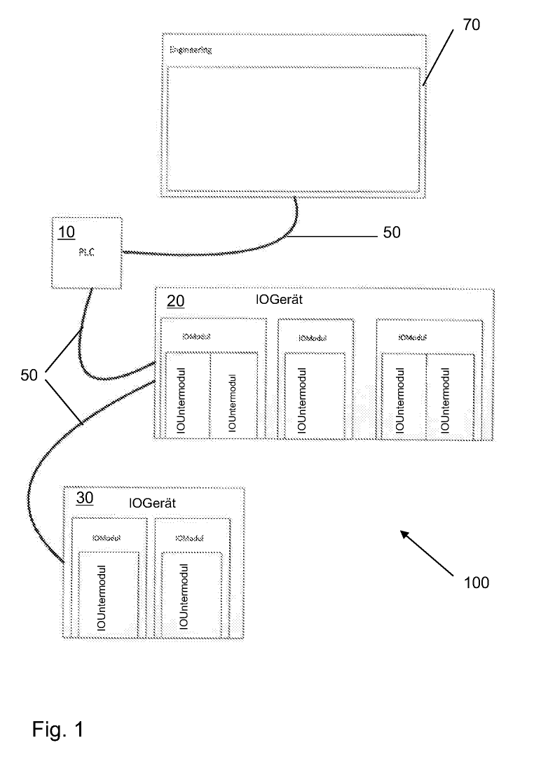

FIG. 1 shows an automation system 100 comprising automation components 10, 20, and 30. Automation system 100 is intended to be employed for automating various manufacturing steps within a manufacturing plant that is not shown in detail. The employed automation components include controller 10 and devices 20 and 30 which are linked with each other via a network 50, e.g. a PROFINET network.

Project planning device 70 which is configured as an engineering tool is likewise connected to the network 50, via a network interface (not shown in detail). In the illustrated example, the project planning device 70 can be used for automating the automation system 100 and in particular the components 10, 20, and 30 thereof, and furthermore in particular for configuring and parameterizing the network 50. For this purpose, the employed types of devices are defined, for example. A large number of settings are made which may concern the network 50, the controller 10 or the devices 20 and 30.

In order for the manufacturing plant to be put into operation, the target configuration and/or target parameterization as created using the project planning device 70 must ultimately be transferred to the automation components. For this purpose it is necessary to convert the configuration and/or parameterization data resulting from the target configuration and/or target parameterization into a format which is understood by the controller 10, for example. In order to ensure correct operation of the automation system, a detailed analysis of the actual configuration and/or actual parameterization of the automation system 100 is performed.

Once the production system including the automation system 100 has been put into operation for the first time, the user (not shown in detail) notices, for example, an elevated network load in the network 50 during operation, which he desires to reduce. As a measure he decides, for example, to change the update time for device 20 from 1 ms to 16 ms, since this would be uncritical for the production process running on the production line. The user makes a corresponding change to the target parameterization using the project planning device 70. In response to this access by the user to the target parameterization, the project planning device automatically initiates and performs a new analysis of the actual configuration and/or of the actual parameterization with respect to the target parameterization. Since no problems were determined during the analysis, the project planning device 70 automatically compiles the parameter data resulting from the target parameterization into a data format that is suitable for the device 20, and subsequently uploads the compiled data onto the device 20, again automatically, and triggers the execution of the data by the device 20 there.

Thanks to the project planning device 70 according to embodiments of the invention, the change made by the user can already be effective on the device 20 within a short time, and the user was able to achieve the goal of a reduced network load.

In other cases, the changes may include adding or removing device entities, moving device entities to another location in the network, or altering properties and settings of devices. The project planning device 70 can, of course, also be used to analyze complex contexts, such as TCP/IP settings within a sub-network, the operability of network 50 which may for instance also comprise a combination of different fieldbuses, based on the available power output in conjunction with the expected power consumption, the operability based on CPU performance of the controller, and much more.

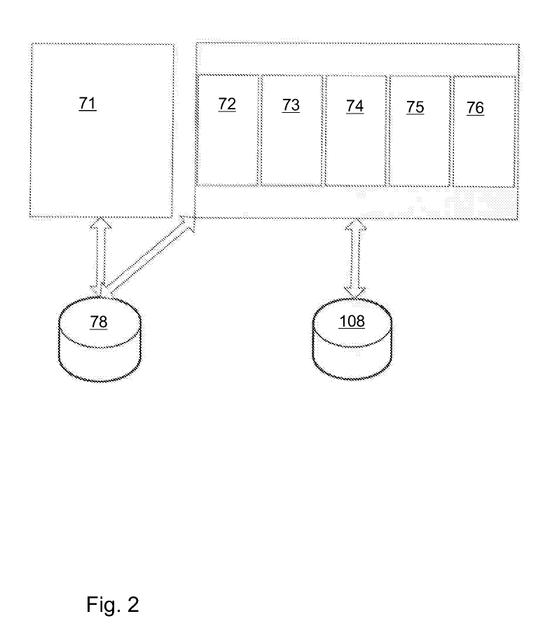

FIG. 2 schematically illustrates a plurality of threads 71 to 76 that are executed in parallel by the project planning device of embodiments of the invention. The project planning device itself is not shown here. However, according to a preferred embodiment it is configured to subdivide both the actual configuration and/or actual parameterization and the target configuration and/or target parameterization into a plurality of segments. The automatic analysis of configurations and/or parameter settings, the compilation of configuration and/or parameterization data, and the transmission of the compiled data need no longer always be performed for the entire configuration and/or parameterization, but rather can selectively address individual ones or a plurality of segments. Such segment-wise analyzing, compiling, and/or transmitting can preferably be performed by the project planning device in a plurality of parallel threads.

By way of example, the thread 71 shown in FIG. 2 is the thread for providing the user interface of the project planning device. Threads 72 and 73 relate to the analyzing of different segments of the configuration and/or parameterization, for example. Threads 74 and 75 relate to the compiling of segment-related configuration and/or parameterization data, for example, while thread 76 relates to the transmission of compiled data, by way of example. The number and division of the threads may, of course, be implemented differently and may in particular change dynamically, depending on which configuration and/or parameterization tasks are to be carried by or using the project planning device.

Data pool 108 in FIG. 2 is intended to illustrate the entire actual configuration and/or actual parameterization of the automation system 100, to which the project planning device has read access during an analysis or has write access during the uploading of new data onto an automation component, for example.

Similarly thereto, data pool 78 is intended to illustrate the entire target configuration and/or target parameterization which was created using the project planning device and which is available for processing, compiling, or transmitting.

### LIST OF REFERENCE NUMERALS

10 Controller
20 Device
30 Device
50 Network
70 Project planning device
71-76 Threads
78 Data pool
100 Automation system
108 Data pool

1. A project planning device for one of configuring and parameterizing automation components of an automation system, comprising a user interface and a network interface; the project planning device being:
operable to create one of a target configuration and a target parameterization for an automation system;
adapted to automatically detect accesses to one of the target configuration and the target parameterization based on predefinable access types;
connectable to a network of an actual automation system via the network interface;
operable to analyze a connected actual automation system with respect to one of the actual configuration and the actual parameterization thereof; and
adapted to automatically initiate and perform the analyzing in response to one of a detected access and a signal which is a predefinable regularly recurring signal.

2. The project planning device of claim 1, configured for automatically analyzing one of the actual configuration and the actual parameterization in comparison to one of the created target configuration and the target parameterization.

3. The project planning device of claim 1, configured for automatically presenting the analysis result, in particular immediately after availability thereof.

4. The project planning device of claim 1, configured for automatically segmenting one of the actual configuration and the actual parameterization, and one of the target configuration and the target parameterization, based on the at least one available analysis result, and configured for automatically analyzing individual segments of one of the actual configuration and the actual parameterization.

5. The project planning device of claim 4, configured for automatically associating the segments of one of the actual configuration and the actual parameterization, with the respectively corresponding segments of one of the target configuration and the target parameterization, and configured for automatically analyzing a segment of one of the actual configuration and the actual parameterization in response to a detected access to a segment of one of the target configuration and the target parameterization associated with this segment.

6. The project planning device of claim 1, configured for automatically converting one of configuration and parameterization data which are resulting from one of the target configuration and the target parameterization into a format that can be interpreted by the automation components, in response to a detected access or in response to a signal which is a predefinable regularly recurring signal.

7. The project planning device of claim 1, configured for automatically converting one of configuration and parameterization data which are resulting from at least one segment of one of the target configuration and the target parameterization into a format that can be interpreted by the automation components, in response to a detected access to said at least one segment of the one of target configuration and target parameterization or in response to a signal which is a predefinable regularly recurring signal.

8. The project planning device of claim 6, configured for automatically uploading onto at least one automation component one of the configuration data and the parameterization data that have been converted into the interpretable format.

9. The project planning device of claim 8, configured for automatically triggering application or execution of one of the configuration data and the parameterization data uploaded onto the automation component.

10. The project planning device of claim 1, wherein the functionality for one of configuring and parameterizing automation components of an automation system is provided in the form of a software component of an engineering tool.

11. A method for one of configuring and parameterizing automation components of an automation system, in particular for being performed using a project planning device, comprising the steps of:
connecting a network of an actual automation system;
creating one of a target configuration and a target parameterization for an automation system;
automatically detecting accesses to one of the target configuration and and the target parameterization based on predefined access types;
automatically initiating and performing the analyzing of the connected actual automation system with respect to one of the actual configuration and actual parameterization thereof, in response to one of a detected access and a signal which is a predefinable regularly recurring signal.

12. The method of claim 11, further comprising the step of: automatically presenting the analysis result, in particular immediately after availability thereof.

13. The method of claim 11, further comprising the step of: automatically segmenting one of the actual configuration and the actual parameterization, and one of the target configuration and the target parameterization, based on the at least one available analysis result, and configured for automatically analyzing individual segments of one of the actual configuration and the actual parameterization.

14. The method of claim 13, further comprising the step of: automatically associating the segments of one of the actual configuration and the actual parameterization, with the respectively corresponding segments of one of the target configuration and the target parameterization, and configured for automatically analyzing a segment of one of the actual configuration and the actual parameterization in response to a detected access to a segment of one of the target configuration and the target parameterization associated with this segment.

15. The method of claim 11, further comprising the step of: automatically converting one of configuration and parameterization data which are resulting from one of the target configuration and the target parameterization into a format that can be interpreted by the automation components, in response to a detected access or in response to a signal which is a predefinable regularly recurring signal.

16. The method of claim 11, further comprising the step of: automatically converting one of configuration and parameterization data which are resulting from at least one segment of one of the target configuration and the target parameterization into a format that can be interpreted by the automation components, in response to a detected access to said at least one segment of the one of target configuration and target parameterization or in response to a signal which is a predefinable regularly recurring signal.

17. The method of claim 15, further comprising the step of: automatically uploading onto at least one automation component one of the configuration data and the parameterization data that have been converted into the interpretable format.

18. The method of claim 17, further comprising the step of: automatically triggering application or execution of one of the configuration data and the parameterization data uploaded onto the automation component.
